(19) United States
(12) Patent Application Publication
(10) Pub. No.: US 2025/0263884 A1
(43) Pub. Date: Aug. 21, 2025

(54) DRYER AND METHOD FOR CONTROLLING THE DRYER

(71) Applicant: SAMSUNG ELECTRONICS CO., LTD., Suwon-si (KR)

(72) Inventors: Jeehoon KIM, Suwon-si (KR); Jongsoo HONG, Suwon-si (KR); Byul NAMKOONG, Suwon-si (KR); Jaehyeok HA, Suwon-si (KR); Chunseong KIM, Suwon-si (KR)

(73) Assignee: SAMSUNG ELECTRONICS CO., LTD., Suwon-si (KR)

(21) Appl. No.: 19/008,892

(22) Filed: Jan. 3, 2025

Related U.S. Application Data
(63) Continuation of application No. PCT/KR2024/020813, filed on Dec. 20, 2024.

(30) Foreign Application Priority Data
Feb. 20, 2024 (KR) 10-2024-0024639

(51) Int. Cl. D06F 58/38; D06F 34/04; D06F 34/18; D06F 34/26; D06F 34/28; D06F 58/02; D06F 103/06; D06F 103/08; D06F 103/32; D06F 105/52; D06F 105/58

(52) U.S. Cl. CPC D06F 58/38; D06F 34/04; D06F 34/18; D06F 34/26; D06F 34/28; D06F 58/02; D06F 2103/06; D06F 2103/08; D06F 2103/32; D06F 2105/52; D06F 2105/58

(57) ABSTRACT

A dryer may include: a drum to accommodate laundry to be dried; a heating element to heat air; a fan to blow the heated air into the drum to dry the laundry; a first temperature sensor to produce first temperature data corresponding to a temperature of the heated air; a second temperature sensor to produce second temperature data corresponding to a temperature in the drum; a dryness sensor in the drum to produce dryness data corresponding to a dryness level of the laundry; and at least one processor configured to: extract a temperature feature point based on the first and second temperature data, extract a dryness feature point based on the dryness data, identify, by an AI model, a material of the laundry based on the temperature feature point and the dryness feature point, and change a dry setting of the dryer based on the identified material.

### CROSS-REFERENCE TO RELATED APPLICATIONS

This is a continuation application, under 35 U.S.C. § 111(a), of International Application No. PCT/KR2024/020813, filed Dec. 20, 2024, which claims priority under 35 U.S.C. § 119 to Korean Patent Application No. 10-2024-0024639, filed Feb. 20, 2024, in the Korean Intellectual Property Office, the disclosures of which are incorporated herein in their entireties by reference.

### TECHNICAL FIELD

The disclosure relates to a dryer that is able to detect a material of the laundry and a method of controlling the dryer.

### BACKGROUND ART

In general, the dryer is a device for drying wet laundry thrown into a drum by forcedly blowing hot air into the drum. Such a garment dryer is basically similar in appearance to the drum washer, and is able to dry the laundry by forcedly circulating heated hot air into the drum through a heater and a blower fan.

To efficiently dry the laundry without damage, temperature and intensity of the hot air and rotation speed of the drum need to be changed depending on the material of the laundry.

### DISCLOSURE

### Technical Problem

The disclosure provides a dryer that is able to accurately identify a material of the laundry and a method of controlling the dryer.

The disclosure provides a dryer that is able to identify a material of the laundry without any expensive sensor and a method of controlling the dryer.

The disclosure provides a dryer having an ever-increasing ability to identify a material of the laundry and a method of controlling the dryer.

The disclosure provides a dryer that performs an efficient drying process depending on the material of the laundry and a method of controlling the dryer.

The disclosure provides a dryer that performs a drying process by changing a dry setting depending on the material of the laundry and a method of controlling the dryer.

Technological objectives of the disclosure are not limited to what are mentioned above, and throughout the specification, it will be clearly appreciated by those of ordinary skill in the art that there may be other technological objectives unmentioned.

### Technical Solution

In accordance with the present disclosure, a dryer may include a drum configured to accommodate laundry to be dried; a heating element configured to heat air; a fan configured to blow the heated air into the drum to dry the laundry; a first temperature sensor configured to produce first temperature data corresponding to a temperature of the heated air; a second temperature sensor configured to produce second temperature data corresponding to a temperature in the drum; a dryness sensor in the drum and configured to produce dryness data corresponding to a dryness level of laundry accommodated in the drum; and at least one processor configured to: extract a temperature feature point based on the first temperature data produced by the first temperature sensor and the second temperature data produced by the second temperature sensor, extract a dryness feature point based on the dryness data produced by the dryness sensor, identify, by an artificial intelligence (AI) model, a material of the laundry based on the temperature feature point and the dryness feature point, and change a dry setting of the dryer based on the identified material.

The at least one processor may be further configured to extract the temperature feature point based on a difference between the temperature of the heated air and the temperature in the drum.

The at least one processor may be further configured to: in response to a command to start drying being received, start a drying process according to a default dry setting, and in response to a lapse of a predetermined time after the start of the drying process, identify the material of the laundry.

The at least one processor may be further configured to, in response to the material of the laundry being identified, change the dry setting from the default dry setting to a dry setting corresponding to the identified material.

The dryer may further include: a user interface device, and the at least one processor may be further configured to, in response to the material of the laundry being identified, control the user interface device to provide an interface presenting an inquiry as to whether the identified material is equal to an actual material of the laundry.

The dryer may further include: a communication interface configured to communicate with an external device, and the at least one processor may be further configured to, in response to the material of the laundry being identified, transmit information about the identified material to the external device through the communication interface.

Based on a response to the inquiry indicating that the identified material is not equal to the actual material of the laundry being received by the interface, the at least one processor may be configured to control the user interface device so that the interface presents an inquiry about the actual material of the laundry.

The at least one processor may be further configured to, based on a response to the inquiry about the actual material of the laundry being received by the interface, change the dry setting to a dry setting corresponding to the received response to the inquiry about the actual material of the laundry.

The AI model may be trained based on: first data related to the extracted temperature feature point, second data related to the extracted dryness feature point, third data related to the identified material, and fourth data related to an actual material of the laundry according to a user input.

The AI model may be configured to: calculate a first value based on a first weight assigned to the extracted temperature feature point, calculate a second value based on a second weight assigned to the extracted dryness feature point, and identify the material of the laundry based on the first value and the second value, and the assigned first weight may be updated and the assigned second weight may be updated to train the AI model.

The at least one processor may be further configured to change the dry setting based on the identified material only when a drying course in which no material of the laundry is specified is performed.

The temperature feature point may include a gradient corresponding to a difference between the temperature of the heated air and the temperature in the drum.

The dryness sensor may include an electrode sensor configured to detect a touch with a portion of the laundry which contains moisture during rotation of the drum, and the dryness feature point may include a gradient corresponding to a number of touches detected by the electrode sensor per unit time.

The dry setting may include at least one of a rotation speed of the drum, a rotation speed of the fan, a heating temperature of the heating element, or an operation time of a drying process.

In accordance with the present disclosure, a method of controlling a dryer including a drum, a heating element and a fan for blowing air heated by the heating element into the drum includes extracting a temperature feature point based on processing of first temperature data produced by a first temperature sensor for detecting temperature of the air heated by the heating element and second temperature data produced by a second temperature sensor for detecting temperature in the drum; extracting a dryness feature point based on processing of dryness data produced by a dryness sensor for detecting a dryness level of laundry in the drum; identifying a material of the laundry by inputting the temperature feature point and the dryness feature point to an AI model; and changing a dry setting of the dryer based on the identified material.

### DESCRIPTION OF DRAWINGS

FIG. 1 illustrates an example of an exterior of a dryer, according to an embodiment.

FIG. 2 illustrates an example of a cross-section of a dryer, according to an embodiment.

FIG. 3 illustrates another example of a cross-section of a dryer, according to an embodiment.

FIG. 4 is an example of a block diagram illustrating a configuration of a dryer, according to an embodiment.

FIG. 5 illustrates an example of a flowchart of a method of controlling a dryer, according to an embodiment.

FIG. 6 conceptually illustrates extracting a plurality of feature points, according to an embodiment.

FIG. 7 conceptually illustrates clusters of laundry materials corresponding to a plurality of feature points, according to an embodiment.

FIG. 8 conceptually illustrates a procedure in which a plurality of feature points are input to an artificial intelligence (AI) model and a material of laundry is identified, according to an embodiment.

FIG. 9 illustrates an example of a dry setting corresponding to a material of laundry, according to an embodiment.

FIG. 10 is a flowchart illustrating an example of a procedure for training an AI model, according to an embodiment.

FIG. 11 illustrates an example of an interface provided through a user interface device of a dryer, according to an embodiment.

FIG. 12 illustrates an example of an interface provided through an external device that receives material information from a dryer, according to an embodiment.

FIG. 13 conceptually illustrates training of an AI model, according to an embodiment.

### MODES OF THE INVENTION

Embodiments and features as described and illustrated in the disclosure are merely examples, and there may be various modifications replacing the embodiments and drawings at the time of filing this application.

The terminology used herein is for the purpose of describing particular embodiments only and is not intended to limit the disclosure.

As used herein, the expression “A or B”, “at least one of A and/or B” or “one or more of A and/or B” includes any possible combination of the listed items. For example, “A or B”, “at least one of A and B” or “at least one of A or B” may refer to any case of 1) including only A, 2) including only B, or 3) including both A and B.

For example, the singular forms “a”, “an” and “the” as herein used are intended to include the plural forms as well, unless the context clearly indicates otherwise.

The terms “comprises” and/or “comprising,” when used in this specification, represent the presence of stated features, integers, steps, operations, elements, components or combinations thereof, but do not preclude the presence or addition of one or more other features, integers, steps, operations, elements, components, or combinations thereof.

When an element is mentioned as being “connected to”, “coupled to”, “supported on” or “contacting” another element, it includes not only a case that the elements are directly connected to, coupled to, supported on or contact each other but also a case that the elements are connected to, coupled to, supported on or contact each other through a third element.

Throughout the specification, when an element is mentioned as being located “on” another element, it implies not only that the element is abut on the other element but also that a third element exists between the two elements.

When it is mentioned that a component (e.g., a first component) is (operatively or communicatively) coupled with/to or connected to another component (e.g., a second component), it should be understood that the first component is coupled to the second component directly or through another component (e.g., a third component).

In the disclosure, the expression “configured to” as herein used may be interchangeably used with “suitable for”, “having the capacity to”, “designed to”, “adapted to”, “made to”, or “capable of” according to the given situation. The expression “configured to” may not necessarily mean “specifically designed to” in terms of hardware.

In some situations, an expression “a device configured to do something” may refer to “the device able to do something in cooperation with another device or parts”. For example, “a processor configured to perform A, B and C functions” may refer to a dedicated processor, e.g., an embedded processor for performing A, B and C functions, or a general purpose processor, e.g., a central processing unit (CPU) or an application processor that may perform A, B and C functions by executing at least one software program stored in a memory.

The term including an ordinal number such as “first”, “second”, or the like is used to distinguish one component from another and does not restrict the former component.

Furthermore, the terms, such as “˜part”, “˜block”, “˜member”, “˜module”, etc., may refer to a unit of handling at least one function or operation. For example, the terms may refer to at least one process handled by hardware such as a field-programmable gate array (9)/application specific integrated circuit (ASIC), etc., software stored in a memory, or at least one processor.

Functions related to AI according to embodiments of the disclosure are operated through a processor and a memory. There may be one or more processors. The one or more processors may include a universal processor such as a central processing unit (CPU), an application processor (AP), a digital signal processor (DSP), etc., a graphic processing unit (GPU), a vision processing unit (VPU), etc., or a dedicated artificial intelligence (AI) processor such as a neural processing unit (NPU). The one or more processors may control processing of input data according to a predefined operation rule or an AI model stored in the memory. When the one or more processors are the dedicated AI processors, they may be designed in a hardware structure that is specific to dealing with a particular AI model.

The predefined operation rule or the AI model may be made by learning. Specifically, a predefined operation rule or an AI model being made by learning refers to the predefined operation rule or the AI model established to perform a desired feature (or an object) being made when a basic AI model is trained by a learning algorithm with a lot of training data. Such learning may be performed by a device itself in which AI is performed according to the disclosure, or by a separate server and/or system. Examples of the learning algorithm may include supervised learning, unsupervised learning, semi-supervised learning, or reinforcement learning, without being limited thereto.

The AI model may include a plurality of neural network layers. Each of the plurality of neural network layers may have a plurality of weight values, and perform neural network operation through operation between an operation result of the previous layer and the plurality of weight values. The plurality of weight values owned by the plurality of neural network layers may be optimized by learning results of the AI model. For example, the plurality of weight values may be updated to reduce or minimize a loss value or a cost value obtained by the AI model during a training procedure. An artificial neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, without being limited thereto.

An embodiment of the disclosure will now be described in detail with reference to accompanying drawings. Throughout the drawings, like reference numerals or symbols refer to like parts or components.

A working principle and embodiments of the disclosure will now be described with reference to accompanying drawings.

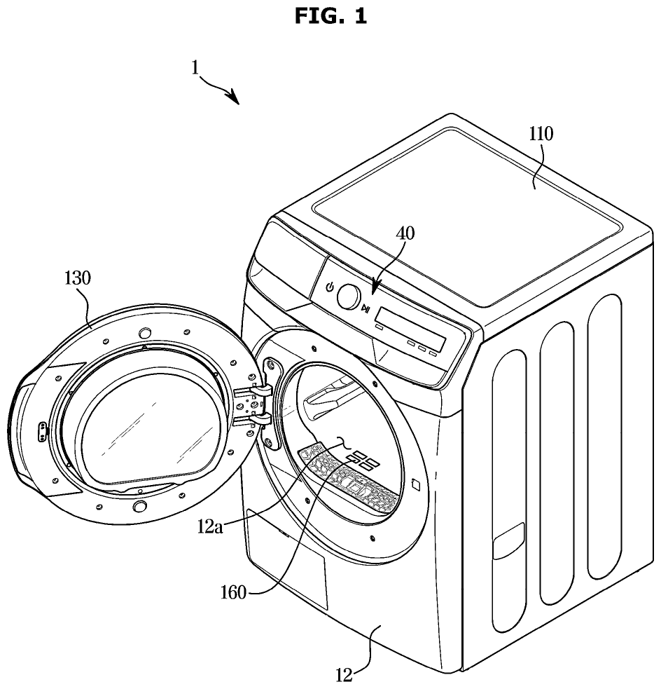

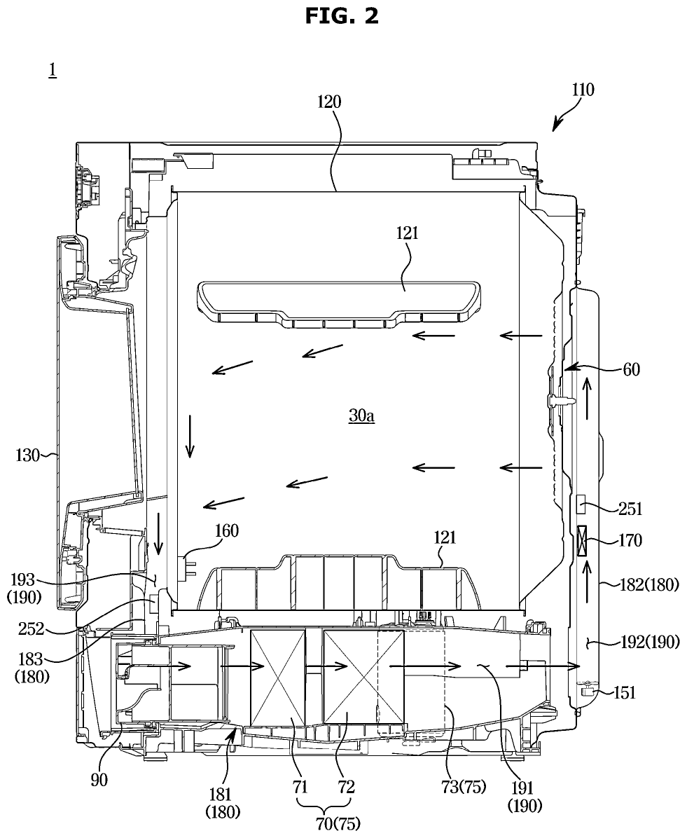

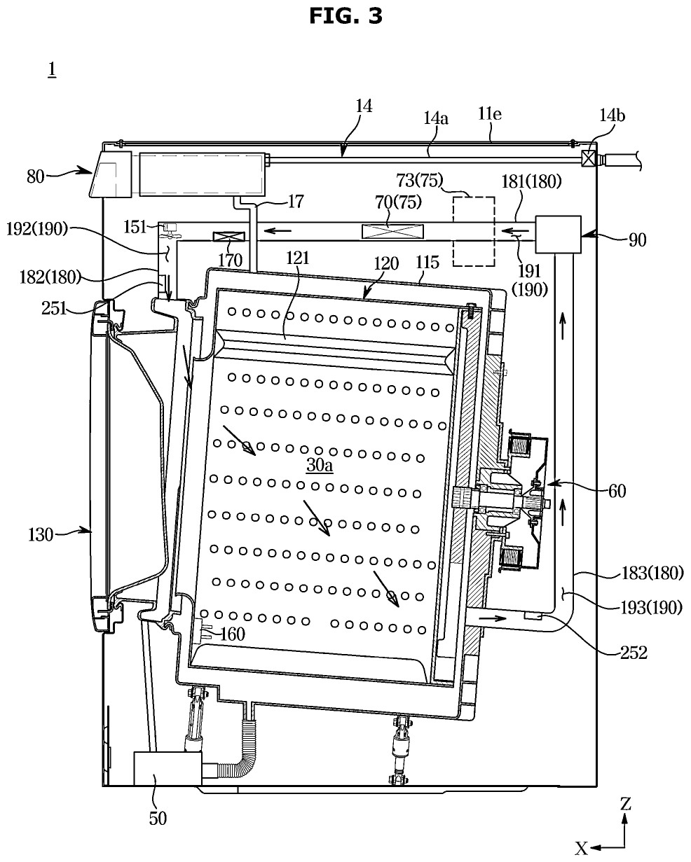

FIG. 1 illustrates an example of an exterior of a dryer, according to an embodiment. FIG. 2 illustrates an example of a cross-section of a dryer, according to an embodiment. FIG. 3 illustrates another example of a cross-section of a dryer, according to an embodiment.

A dryer shown in FIG. 2 is one that may perform only a drying process for drying clothes.

A dryer shown in FIG. 3 is one that may perform both a washing process for washing clothes and the drying process for drying the clothes.

Referring to FIGS. 1, 2 and 3, a dryer according to an embodiment may include a main body 110 that forms an exterior, a drum 120 rotationally installed in the main body 110 and accommodating laundry, a door 130 for opening or closing the drum 120, a driving device 60 for rotating the drum 120, and a heat pump device 75 for producing hot air to dry the laundry (or an object to be dried) in the drum 120.

The laundry may be accommodated in a chamber 30a formed by the drum 120.

The main body 110 may include a front cover 12. An opening 12a may be arranged at the front cover 12, and the door 130 for opening or closing the opening 12a may be rotationally installed at the front cover 12.

On an upper portion of the front cover 12, a user interface device 40 including an input interface for receiving control commands from the user and an output interface for displaying a screen to present various information about operations of the dryer 1 or guiding the user to input may be arranged.

The drum 120 may be shaped like a cylinder with front and rear sides open.

The drum 120 may be rotated clockwise or counterclockwise in the main body 110 by driving force of the driving device 60.

A plurality of lifters 121 for tumbling the laundry may be arranged on an inner circumferential surface of the drum 120. The plurality of lifters 121 may be formed to protrude toward the center from the inner circumferential surface of the drum 120.

A front support plate and a rear support plate are arranged in the front and back of the drum 120, respectively. The front of the drum 120 may be covered by the front support plate fixedly installed on the front of the main body 110, and the back of the drum 120 may be covered by the rear support plate fixedly installed on the back of the main body 110.

The front support plate and the rear support plate may rotationally support the drum 120.

For this, slippery pads may be arranged in a portion where the front support plate and the drum 120 contact and a portion where the rear support plate and the drum 120 contact to reduce frictional resistance, and rollers may be arranged under the front support plate and the rear support plate to rotationally support the drum 120. Accordingly, the drum 120 may be smoothly rotated.

During a drying process, the drum 30 may be rotationally driven by the driving device 60.

The driving device 60 may include a driving motor for generating power for rotating the drum 120 and a driving circuit for operating the driving motor.

In various embodiments, the driving motor of the driving device 60 may be connected only to the drum 120, or connected to the drum 120 and a blower fan 151. In an embodiment, one end of a shaft of the driving motor of the driving device 60 may be coupled with a pulley connected to the drum 120 and the other end may be coupled with the blower fan 151.

Hereinafter, for convenience of explanation, a motor for rotating the drum 120 is defined as a drum motor, and a motor for rotating the blower fan 151 is defined as a fan motor.

The drum motor and the fan motor may be the same motors or different motors.

A dryness sensor 160 may be arranged in the drum 120. The laundry accommodated in the drum 120 may touch the dryness sensor 160 while being rotated, and depending on the dryness level of the laundry, an electric signal measured by the dryness sensor 160 may be different. In other words, the dryness sensor 160 outputs an electric signal corresponding to a dryness level of the laundry accommodated in the drum 120. The dryness level may refer to a level of dryness of the laundry.

The dryness sensor 160 may include an electrode sensor. The electrode sensor may detect a touch with a portion of the laundry that contains moisture during the rotation of the drum 120. The electrode sensor may also be referred to as a touch sensor from a perspective of detecting the touch with a portion of the laundry.

The number of contacting the laundry that contains moisture may be counted by the electrode sensor. In an embodiment, the number of contacting the laundry that contains moisture per unit time (e.g., a minute) may be used to measure the dryness of the laundry. The number of touches with the laundry that contains moisture per unit time (e.g., a minute) may be referred to as the number of touches.

The dryness sensor 160 may detect a current flowing through the moisture when the laundry is still wet to measure a dryness level of the laundry. However, when the laundry tumbling on an outer side in the drum 120 is completely dried while the laundry tumbling on an inner side in the drum 120 is a bit wet, the dryness level detected by the dryness sensor 160 may be a little inaccurate.

In an embodiment, the dryer 1 may include a heating element 200. The heating element may dehumidify and/or heat air supplied into the chamber 30a.

In an embodiment, the heating element 200 may include a heat pump device 75.

The heat pump device 75 may include a heat exchanger 70, a compressor 73 and an expansion valve (not shown).

The heat exchanger 70 may include an evaporator 71 and a condenser 72.

The heat pump device 75 has a refrigerant circulation path that passes from the compressor 73 through the condenser 72, the expansion valve and the evaporator 71 and back to the compressor, and the condenser 72 and the evaporator 71 serve as the heat exchanger 70.

The evaporator 71 may be located farther upstream of the air flow than the condenser 72.

The heat exchanger 70 may heat the air supplied into the chamber 30a.

The air that has passed through the chamber 30a formed by the drum 120 may be dried while passing the evaporator 71, heated while passing the condenser 72, and may flow back into the chamber 30a.

In an embodiment, the heating element 200 may include a heater 170. The heater 170 is to heat the air supplied into the chamber 30a, and may operate for a predetermined time at the beginning of the drying process.

In an embodiment, the heater 170 may be arranged downstream from the heat exchanger 70, but is not limited thereto and may be arranged upstream from the heat exchanger 70.

The blower fan 151 may force the air that has passed through the chamber 30a formed by the drum 120 to pass the evaporator 71 and the condenser 72 and then flow back into the chamber 30a.

In other words, the blower fan 151 may make an air flow that circulates to the inside (chamber) 30a of the drum 120 and the heating element 200. For this, the blower fan 151 may be arranged in a duct 180 in which the air discharged from the drum 120 flows.

In an embodiment, the blower fan 151 may be arranged downstream from the condenser 72, but the location of the blower fan 151 is not limited thereto, and the blower fan 151 may be installed anywhere at which an air flow may be made in the duct 180.

In an embodiment, the dryer 1 may include a lint removing device 90. In addition to the door 130 that opens or closes the opening 12a, an auxiliary door may be further arranged at the front cover 12 to open or close space in which the lint removing device 90 is accommodated.

The user may take out or put in the lint removing device 90 through the auxiliary door.

The lint removing device 90 may collect and remove the lint contained in the air discharged from the chamber 30a. For this, the lint removing device 90 may include a filter.

The lint removing device 90 may be arranged in the duct 180 where the air discharged from the drum 120 flows. The lint removing device 90 may be arranged upstream from the heat exchanger 70 to prevent accumulation of the lint on the heat exchanger 70 by removing the lint in the air that has passed the drum 120.

The dryer shown in FIG. 2 and the dryer 1 shown in FIG. 3 differ in terms of whether a washing process is possible.

The dryer shown in FIG. 2 may perform a drying process that supplies hot air into the chamber 30a while rotating the drum 120.

The dryer shown in FIG. 3 may perform not only the drying process that supplies hot air into the chamber 30a while rotating the drum 120 but also a laundry cycle for washing the laundry accommodated in the chamber 30a. The laundry cycle may include a water supply process, a rinsing process, a washing process and/or a dehydrating process.

Referring to FIG. 2, in the dryer 1 according to an embodiment, the heat exchanger 70, the blower fan 151 and the lint removing device 90 may be arranged in a lower portion of the main body 110. For example, the heat exchanger 70, the blower fan 151, and the lint removing device 90 may be arranged in the duct 180.

A first duct 181 may be located underneath the drum 120 to guide the air discharged from the drum 120 to be dehumidified, heated and flow back into the drum 120. The heat exchanger 70 may be accommodated in the first duct 181. The first duct 181 may be referred to as a lower frame. A first circulation path 191 may be formed in the first duct 181.

A second duct 181 may be located behind the drum 120 to guide air toward the drum 120. The air that has passed the heat exchanger 70 may be supplied into the drum 120 through the second duct 182. The second duct 182 may form a portion of the circulation path 190. The blower fan 151 may be accommodated in the second duct 182. A second circulation path 192 may be formed in the second duct 182. In an embodiment, the heater 170 may be arranged in the second duct 182.

A third duct 183 may be arranged in front of the drum 120 to guide the air of the inside 30a of the drum to go to the heat exchanger 70. The air from inside 30a of the drum may flow to the heat exchanger 70 through the third duct 183. The third duct 183 may form a portion of the circulation path 190. A third circulation path 193 may be formed in the third duct 183.

In various embodiments, the lint removing device 90 may be arranged in the first duct 181, the second duct 182 or the third duct 183.

In an embodiment, the lint removing device 90 may be arranged in the third duct 183.

The second duct 182 and the third duct 183 may allow the air from the inside 30a of the drum to circulate through the circulation path 190 in the main body 110.

The dryer 1 may further include the circulation path 190. The circulation path 190 may include the first circulation path 191, the second circulation path 192 and the third circulation path 193. The first circulation path 191 may be formed by the first duct 181, the second circulation path 192 may be formed by the second duct 182, and the third circulation path 193 may be formed by the third duct 183.

The blower fan 151 may circulate the air in the circulation path 190.

By circulating the air in the circulation path 190, the blower fan 151 may force the air discharged from the drum 120 into the duct 180 to be heated by the heating element 200 and then flow back into the drum 120.

Referring to FIG. 3, the dryer 1 in the embodiment shown in FIG. 3 may further include components for performing the laundry cycle as compared to the dryer 1 in the embodiment shown in FIG. 2.

In an embodiment, the dryer 1 may include a tub 115 arranged in the main body 110, and the drum 120 arranged in the tub 115 to accommodate and rotate the laundry.

A water supply device 14 may be arranged above the tub 115. The water supply device 14 may include a water supply valve 14b for controlling water supply and a water supply tube 14a. A detergent supply device 80 may also be installed above the tub 115 to supply a detergent into the tub 115 during the water supply process. The detergent supply device 80 may be installed at the front cover 12 as well. The detergent supply device 80 may be arranged in the main body 110. The water flowing into the dryer 1 through the water supply device 14 may flow into the detergent supply device 80.

In various embodiments, the detergent supply device 80 may be installed underneath the tub 115.

The detergent supply device 80 may be connected to the tub 115 through a supply tube 17. Water supplied through the water supply tube 14a passes through the detergent supplier 80 to be mixed with the detergent, and the mixed water in which the water and the detergent are mixed may be supplied into the tub 115.

The water supplied into the dryer 1 through the water supply device 14 may flow into the detergent supply device 80. The water passing the water supply tube 14a may flow into a detergent container. For example, the water supply tube 14a may be arranged on the detergent container to supply the water into the detergent container arranged below. A detergent may be accommodated in the detergent container, and the water supplied from the water supply tube 14a into the detergent container may be mixed with the detergent. The water mixed with the detergent in the detergent container may flow into the tub 115. For example, a supply tub 17 may be connected to the detergent container and the tub 115 under the detergent container to supply the water mixed with the detergent in the detergent container to the tub 115.

The detergent container may be arranged at the front cover 12 to be pulled out. In various embodiments, the detergent container and the lint removing device 90 may be arranged at the front cover 12 to be pulled out. Although the lint removing device 90 is shown as being arranged behind the tub 115, the lint removing device 90 may be arranged on a side of the heat exchanger 70 above the tub 115. The lint removing device 90 may be arranged between a top surface 11e of the main body 110 and the tub 115. The heat exchanger 70 may be arranged between the top surface 11e of the main body 110 and the tub 115.

The tub 115 may store the mixed water in which water and the detergent are mixed, and have a substantially cylindrical shape. The tub 115 may be fixed to the inside the main body 110. An opening 12a of the front cover 12 and the tub 115 may be connected by a diaphragm. The diaphragm may seal the space between the front cover 12 and the tub 115.

A drain device 50 including a drain tube (not shown), a drain valve (not shown), a drain pump, etc., to drain the water from the tub 115 may be installed underneath the tub 115.

The tub 115 is arranged to be elastically supported from the main body 110 by a spring (not shown) above and dampers below. Specifically, the spring and the dampers may be arranged to absorb vibration energy between the tub 115 and the main body 110 to dampen vibrations that occur during the rotation of the drum 120 and that are transferred to the tub 115 and the main body 110.

In the dryer 1 according to an embodiment, the heat exchanger 70, the blower fan 151 and the lint removing device 90 may be arranged in an upper portion of the main body 110. For example, the heat exchanger 70, the blower fan 151, and the lint removing device 90 may be arranged in the duct 180.

The first duct 181 may be located above the drum 120 and the tub 115 to guide the air discharged from the drum 120 to be dehumidified, heated and flow back into the drum 120. The heat exchanger 70 may be accommodated in the first duct 181. The first duct 181 may be referred to as an upper frame. The first circulation path 191 may be formed in the first duct 181.

The second duct 182 may be located in front of the drum 120 and the tub 115 to guide air toward the drum 120. The air that has passed the heat exchanger 70 may be supplied into the drum 120 through the second duct 182. The second duct 182 may form a portion of the circulation path 190. The blower fan 151 may be accommodated in the second duct 182. The second circulation path 192 may be formed in the second duct 182.

The third duct 183 may be arranged behind the drum 120 and the tub 115 to guide the air from the inside 30a of the drum to go to the heat exchanger 70. The air from inside 30a of the drum may flow to the heat exchanger 70 through the third duct 183. The third duct 183 may form a portion of the circulation path 190. A third circulation path 193 may be formed in the third duct 183. In an embodiment, the heater 170 may be arranged in the third duct 183.

In various embodiments, the lint removing device 90 may be arranged in the first duct 181, the second duct 182 or the third duct 183.

In an embodiment, the lint removing device 90 may be arranged in the first duct 182.

The second duct 182 and the third duct 183 may allow the air from the inside 30a of the drum to circulate through the circulation path 190 in the main body 110. Furthermore, as the air discharged from the second duct 182 may flow into the tub 115 and the drum 120 through the diaphragm, the diaphragm may also allow the air to circulate through the circulation path 190 in the main body 110.

The dryer 1 may further include the circulation path 190. The circulation path 190 may include the first circulation path 191, the second circulation path 192 and the third circulation path 193. The first circulation path 191 may be formed by the first duct 181, the second circulation path 192 may be formed by the second duct 182, and the third circulation path 193 may be formed by the third duct 183.

The blower fan 151 may circulate the air in the circulation path 190.

By circulating the air in the circulation path 190, the blower fan 151 may force the air discharged from the drum 120 into the duct 180 to be heated by the heating element 200 and then flow back into the drum 120.

The dryer 1 may include a first temperature sensor 251 for measuring temperature of the air flowing to the inside 30a of the drum.

The first temperature sensor 251 may detect the temperature of air heated by the heating element 200.

In an embodiment, the first temperature sensor 251 may be arranged around the heating element 200.

The first temperature sensor 251 may be arranged in the circulation path 190. In various embodiments, the first temperature sensor 251 may be arranged downstream from the heater 170, but the position of the first temperature sensor 251 is not limited thereto. For example, the first temperature sensor 251 may be arranged downstream from the heat pump device 75 or may be arranged downstream from the heating element 200.

The dryer 1 may further include a second temperature sensor 252 for detecting temperature of the inside 30a of the drum.

The detecting of the temperature of the inside 30a of the drum may include detecting temperature of the air discharged from the drum 120 to the duct 180.

The detecting of the temperature of the air discharged from the drum 120 to the duct 180 may include detecting temperature of air heated by the heating element 200, supplied to the inside 30a of the drum and having passed through the laundry accommodated in the drum 120.

In an embodiment, the second temperature sensor 252 may be arranged inside 30a of the drum and/or in the third duct 183. In various embodiments, the second temperature sensor 251 may be arranged upstream from the heating element 200, but the position of the second temperature sensor 251 is not limited thereto.

As will be described later, according to the disclosure, the temperature of the air heated by the heating element 200 and the temperature of the inside 30a of the drum may be used to accurately identify a dryness level of the laundry.

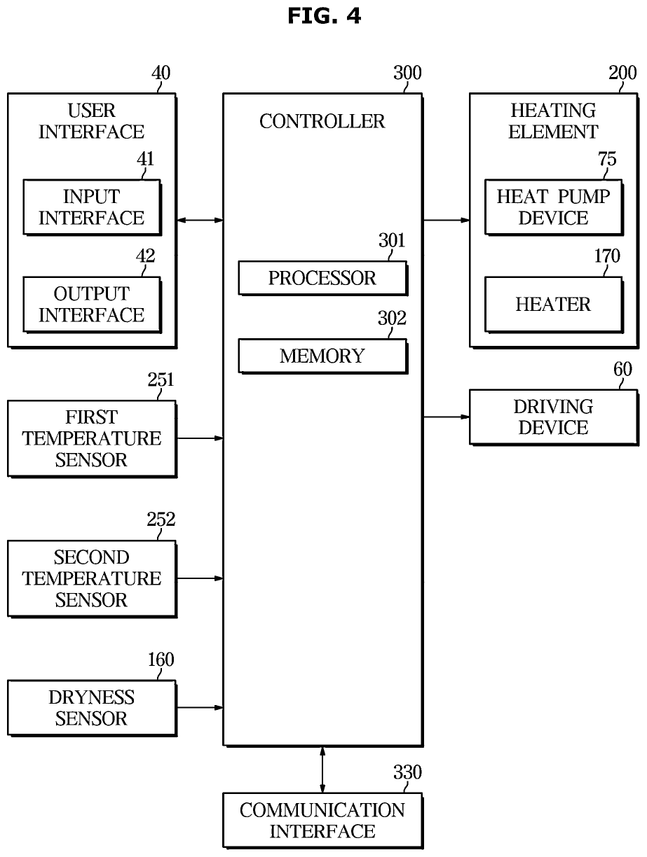

FIG. 4 is an example of a block diagram illustrating a configuration of a dryer, according to an embodiment.

Referring to FIG. 4, the dryer 1 in an embodiment may include the user interface device 40, the heating element 200, the driving device 60, a communication interface 330, the first temperature sensor 251, the second temperature sensor 252, the dryness sensor 160 and/or a controller 300.

In an embodiment, the dryer 1 may further include a water supply device, a detergent supply device, a drain device, etc., to perform a washing process in addition to the drying process.

In an embodiment, the dryer 1 may not include some components (e.g., the heater 170).

The user interface device 40 may include at least one input interface 41 and at least one output interface 42.

The at least one input interface 41 may convert sensory information received from the user into an electric signal.

The at least one input interface 41 may include a power button, an operation button, a coarse selection dial (or course selection buttons) and washing/rinsing/dehydrating/drying/dry setting buttons. The at least one input interface 41 may include, for example, a tact switch, a push switch, a slide switch, a toggle switch, a micro switch, a touch switch, a touch pad, a touch screen, a jog dial, and/or a microphone.

The at least one output interface 42 may send various information relating to operation of the dryer 1 to the user by generating the sensory information.

For example, the at least one output interface 42 may deliver information relating to a dry course and an operation time of the dryer 1, a washing course and an operation time of the dryer 1, and wash settings/rinse settings/dehydration settings/dry settings to the user. The information relating to the operation of the dryer 1 may be output through a screen, an indicator, a voice, etc. The at least one output interface 42 may include, for example, a liquid crystal display (LCD) panel, a light emitting diode (LED) panel, a speaker, etc.

The driving device 60 may include a drum motor for providing driving power to rotate the drum 120, and a driving circuit for driving the drum motor. The drum motor may operate based on a driving current applied from the driving circuit. The driving device 60 may operate based on a control signal of the controller 300.

In an embodiment, the controller 300 may control the driving device 60 to rotate the drum 120 during the drying process.

In an embodiment, the driving device 60 may include a fan motor for providing driving power to rotate the blower fan 151, and a driving circuit for driving the fan motor.

As described above, the drum motor and the fan motor may be the same motors or different motors.

The controller 300 controlling the driving device 60 may include controlling rotation speed of the drum 120.

The controller 300 controlling the driving device 60 may include controlling rotation speed of the blower fan 151.

The heating element 200 may include the heat pump device 75 and/or the heater 170.

The heat pump device 75 may include the compressor 73 for compressing the refrigerant, the expansion valve and the heat exchanger 70. The compressor 73 may operate based on a control signal from the controller 300. The heat pump device 75 may heat air supplied to the inside 30a of the drum.

The heater 170 may heat the air supplied to the inside 30a of the drum. The heater 170 may operate based on a control signal from the controller 300.

In an embodiment, the controller 300 may control the compressor 73 and/or the heater 170 to maintain the air flowing to the inside 30a of the drum at a predetermined target temperature during the drying process.

For example, the controller 300 may control the compressor 73 and/or the heater 170 to maintain a temperature detected by the first temperature sensor 251 at the predetermined target temperature in the drying process.

The communication interface 330 may communicate with an external device (e.g., a server, a user equipment and/or a home appliance) wiredly and/or wirelessly.

The communication interface 330 may include at least one of a short-range communication module or a long-range communication module.

The communication interface 330 may transmit data to the external device or receive data from the external device. For example, the communication interface 330 may establish communication with the server, the user equipment and/or another home appliance to transmit or receive various data.

For this, the communication interface 330 may support establishment of a direct (e.g., wired) communication channel or a wireless communication channel between external devices, and communication through the established communication channel. In an embodiment, the communication interface 330 may include a wireless communication module (e.g., a cellular communication module, a short-range wireless communication module or a GNSS communication module) or a wired communication module (e.g., a LAN communication module or a power-line communication module). A corresponding one of the communication modules may communicate with an external device over a first network (e.g., a short-range communication network such as bluetooth, Wi-Fi direct or IrDA) or a second network (e.g., a remote communication network such as a legacy cellular network, a 5G network, a next generation communication network, the Internet, or a computer network (e.g., a LAN or WAN). These various types of communication modules may be integrated into a single component (e.g., a single chip) or implemented as a plurality of separate components (e.g., a plurality of chips).

The short-range communication module may include a bluetooth communication module, a BLE communication module, an NFC module, a WLAN, e.g., Wi-Fi, communication module, a Zigbee communication module, an IrDA communication module, a WFD communication module, an UWB communication module, an Ant+ communication module, a uWave communication module, etc., without being limited thereto.

The long-range communication module may include a communication module for performing various types of long-range communication and include a mobile communication module. The mobile communication module transmits and receives RF signals to and from at least one of a base station, an external terminal, or a server in a mobile communication network.

In an embodiment, the communication interface 330 may communicate with an external device such as a server, a user equipment, another home appliance, etc., through a nearby access point (AP). The AP may connect a local area network (LAN) connected to the dryer 1, another home appliance and/or user equipment to a wide area network (WAN) connected to the server. The dryer 1, the other home appliance and/or the user equipment may be connected to the server through the WAN.

The first temperature sensor 251 may detect temperature of air heated by the heating element 200. For example, the first temperature sensor 251 may produce first temperature data corresponding to the temperature of air heated by the heating element 200 (hereinafter, first temperature).

The first temperature data produced by the first temperature sensor 251 may be sent to the controller 300.

The second temperature sensor 252 may detect temperature of the inside 30a of the drum. For example, the second temperature sensor 252 may produce second temperature data corresponding to the temperature of the inside 30a of the drum (hereinafter, second temperature).

The second temperature data produced by the second temperature sensor 252 may be sent to the controller 300.

The dryness sensor 160 may detect a dryness level of the laundry of the inside 30a of the drum. For example, the dryness sensor 160 may produce dryness data corresponding to the dryness level of the laundry inside the drum.

The dryness data corresponding to the dryness level of the laundry may include data related to the number of touches with the laundry that contains moisture.

The dryness data produced by the dryness sensor 160 may be sent to the controller 300.

The controller 300 may control various components of the dryer 1 (e.g., the driving device 60, the heat pump device 75, the heater 170, the user interface device 40 and communication interface 330). The controller 300 may control the various components of the dryer 1 to perform at least one process including water supply, washing, rinsing, dehydrating and/or drying according to a user input. For example, the controller 300 may control the driving device 60 to control the rotation speed of the drum 120 and/or the rotation speed of the blower fan 151, or control the heating element 200 to maintain the air flowing to the inside 30a of the drum at the predetermined target temperature.

The target temperature of the air supplied to the inside 30a of the drum may also be referred to as heating temperature of the heating element 200.

The controller 300 may process sensor data produced by various sensors (e.g., the first temperature sensor 251, the second temperature sensor 252 and/or the dryness sensor 160), and perform various operations based on the processing of the sensor data produced by the various sensors.

The controller 300 may include hardware such as a CPU, a micom or a memory, and software such as a control program. For example, the controller 300 may include at least one memory 302 that stores an algorithm for controlling operations of the components in the dryer 1, and at least one processor 301 for performing the aforementioned operations and the following operations using the data stored in the at least one memory 302. The memory 302 and the processor 301 may be implemented in separate chips. The processor 301 may include one, two or more processor chips or one, two or more processing cores. The memory 302 may include one, two or more memory chips or one, two or more memory blocks. Alternatively, the memory 302 and the processor 301 may be implemented in a single chip.

The at least one memory 302 may store data required for various embodiments. The memory 302 may be implemented in the form of a memory embedded in or detachable from the dryer 1 depending on the data storage use. For example, data for operating the dryer 1 may be stored in the memory embedded in the dryer 1 and data for an extended function of the dryer 1 may be stored in the memory detachable from the dryer 1. In the meantime, the memory embedded in the dryer 1 may be implemented with at least one of a volatile memory (e.g., a dynamic random access memory (DRAM), a static RAM (SRAM), or a synchronous dynamic RAM (SDRAM), etc.) or a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard drive or a solid state drive (SSD)). The memory detachable from the dryer 1 may be implemented in such a format as a memory card (e.g., compact flash (CF), secure digital (SD), micro-SD, mini-SD, extreme digital (xD), multi-media card (MMC), etc.) or an external memory (e.g., USB memory) connectable to a USB port.

In an embodiment, the at least one memory 302 may store a cycle profile corresponding to a dry course and an operation time of the dryer 1, a washing course and an operation time of the dryer 1, and wash settings/rinse settings/dehydration settings/dry settings. The cycle profile may include rotation speed of the drum 120, rotation speed of the blower fan 151, a target temperature of air supplied to the inside 30a of the drum, etc., in a drying process.

In an embodiment, the at least one memory 302 may store instructions, an algorithm and/or a program for extracting feature points by processing sensor data produced by various sensors (e.g., the first temperature sensor 251, the second temperature sensor 252 and/or the dryness sensor 160) of the dryer 1.

In an embodiment, the at least one memory 302 may store an AI model. As will be described later, the AI model may be trained to identify a material of the laundry by using at least one factor obtained based on the processing of the sensor data produced by the various sensors (e.g., the first temperature sensor 251, the second temperature sensor 252 and/or the dryness sensor 160) of the dryer 1 as input data.

In various embodiments, the AI model may be stored in a server as well or only in the server.

The at least one processor 301 controls general operation of the dryer 1. Specifically, the at least one processor 301 may be connected to the respective components of the dryer 1 to control general operation of the dryer 1. For example, the at least one processor 301 may be electrically connected to the memory 302 to control general operation of the dryer 1. The processor 301 may include one or more processors.

The at least one processor 301 may execute at least one instruction stored in the memory 302 to perform operation of the dryer 1 according to various embodiments.

The at least one processor 301 may include one or more of a central processing unit (CPU), a graphics processing unit (GPU), an accelerated processing unit (APU), a many integrated core (MIC), a digital signal processor (DSP), a neural processing unit (NPU), a hardware accelerator or a machine learning accelerator. The at least one processor 301 may control one or any combination of the other components of the dryer 1, and perform a communication related operation or data processing. The at least one processor 301 may execute at least one program or instruction stored in the memory 302. For example, the at least one processor 301 may execute the at least one instruction stored in the memory 302 to perform a method according to at least one embodiment of the disclosure.

In a case that the method according to the at least one embodiment of the disclosure includes a plurality of operations, the plurality of operations may be performed by at least one processor or a plurality of processors. For example, when a first operation, a second operation and a third operation are performed in a method according to at least one embodiment, all the first operation, the second operation and the third operation may be performed by a first processor, or the first operation and the second operation may be performed by the first processor (e.g., a universal processor) and the third operation may be performed by a second processor (e.g., an AI dedicated processor).

The at least one processor 301 may be implemented with a single core processor having a single core, or may be implemented with at least one multicore processor having multiple cores (e.g., homogeneous multi cores or heterogeneous multi cores). When the at least one processor 301 is implemented with the multicore processor, each of the multiple cores included in the multicore processor may include an internal processor memory such as a cache memory or an on-chip memory, and a common cache shared by the multiple cores may be included in the multicore processor. Furthermore, each (or some) of the multiple cores included in the multicore processor may independently read and execute program instructions to implement a method according to at least one embodiment of the disclosure, or all (or some) of the plurality of cores may be involved to read and execute program instructions to implement the method according to the at least one embodiment of the disclosure.

In a case that the method according to the at least one embodiment of the disclosure includes a plurality of operations, the plurality of operations may be performed by one or multiple cores included in the multicore processor. For example, when a first operation, a second operation and a third operation are performed in a method according to at least one embodiment, all the first operation, the second operation and the third operation may be performed by a first core included in the multicore processor, or the first operation and the second operation may be performed by the first core included in the multicore processor and the third operation may be performed by a second core included in the multicore processor.

In embodiments of the disclosure, the processor may refer to an SoC in which at least one processor and other electronic parts are integrated, a single core processor, a multicore processor, or a core included in the single core processor or multicore processor, and the core may be implemented with a CPU, a GPU, an APU, an MIC, a DSP, an NPU, a hardware accelerator or a machine learning accelerator, without being limited thereto. In the following description, for convenience of explanation, the at least one processor 301 will be referred to as the processor 301.

For example, the controller 300 may be mounted on a printed circuit board provided on the rear surface of the control panel, which is an example of the user interface device 40.

The controller 300 may be electrically connected to the user interface device 40, the driving device 60, the heating element 200, the communication interface 330, the first temperature sensor 251, the second temperature sensor 252 and/or the dryness sensor 160.

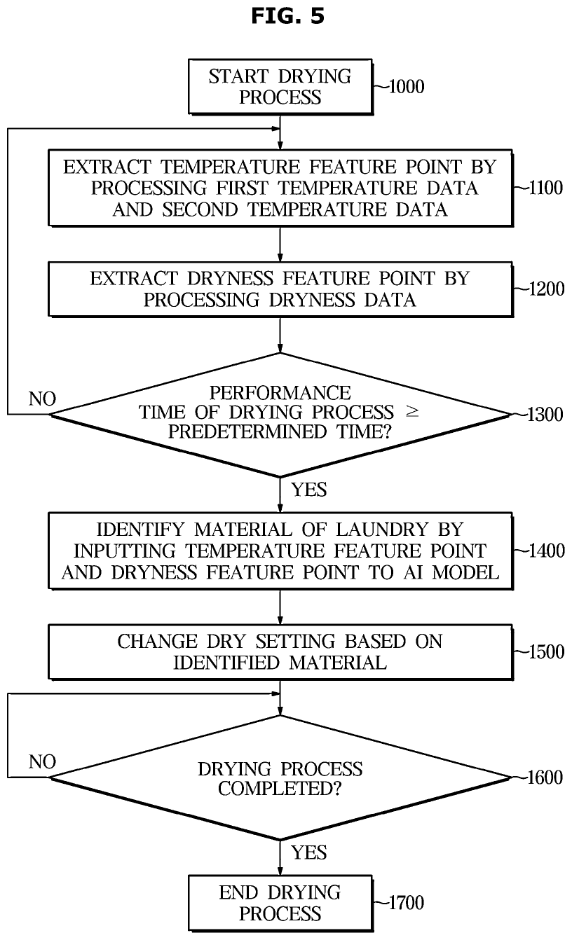

FIG. 5 illustrates an example of a flowchart of a method of controlling a dryer, according to an embodiment.

Referring to FIG. 5, the dryer 1 according to an embodiment may start a drying process based on receiving of a command to start the drying process through the user interface device 40, in 1000.

In an embodiment, the dryer 1 may provide a plurality of drying courses.

The user may select one of the plurality of drying courses through the user interface device 40, and then start the selected drying course.

Materials of the laundry may be classified into mixed ones, towels, cotton, denim, blended ones, bedclothes, waterproof materials, baby clothes, etc.

The plurality of drying courses may include at least one drying course that specifies a material of the laundry and a drying course in which the material of the laundry is not specified.

The at least one drying course that specifies the material of the laundry may include not only a course having a name, part of which includes the material of the laundry such as, for example, a towel drying course, a bedclothes drying course, a blended drying course, a baby clothes drying course, etc., but also all the drying courses in which the material of the laundry may be specified.

The drying course that does not specify the material of the laundry may include a standard drying course, an intensive drying course and/or an AI drying course, as general courses.

In an embodiment, at least some (e.g., operation 1500) of operations included in the method of controlling the dryer 1 shown in FIG. 5 may be performed only when the drying course in which the material of the laundry is not specified is selected among the plurality of drying courses.

On receiving a command to start drying of the dryer 1, the processor 301 may start a drying process according to a default dry setting.

The dry setting of the dryer 1 may include at least one of the rotation speed of the drum 120, the rotation speed of the blower fan 151, or heating temperature of the heating element 200.

The default drying setting is a dry setting set in advance to correspond to a drying course regardless of the weight and/or material of the laundry, and data about default dry settings for the plurality of drying courses may be stored in the memory 302.

On receiving the command to start drying of the dryer 1, the processor 301 may control the driving device 60 and/or the heating element 200 based on the rotation speed of the drum 120, rotation speed of the blower fan 151 or heating temperature of the heating element 200 according to the default dry setting.

In an embodiment, the processor 301 may perform a weight detection process based on the start of the drying process.

The processor 301 may control a motor (e.g., the drum motor) of the driving device 60 to be on/off repeatedly to perform the weight detection process, and may measure a load (weight of the laundry) inside the drum 120 based on counter electromotive force that is generated when the motor is off. In another example, the processor 301 may provide a target speed command to rotate the drum 120 at a first target speed to the driving device 60, and measure the load (weight of the laundry) in the drum 120 based on the time spent until the drum 120 reaches the first target speed.

The memory 302 may store data about a weight value of the laundry measured through the weight detection process.

The processor 301 may extract a temperature feature point based on processing of the first temperature data produced by the first temperature sensor and the second temperature data produced by the second temperature sensor, in 1100.

The processor 301 may extract a dryness feature point based on processing of the dryness data produced by the dryness sensor, in 1200.

The processor 301 may perform the operation 1100 of extracting the temperature feature point and the operation 1200 of extracting the dryness feature point, until a predetermined time elapses after the start of the drying process.

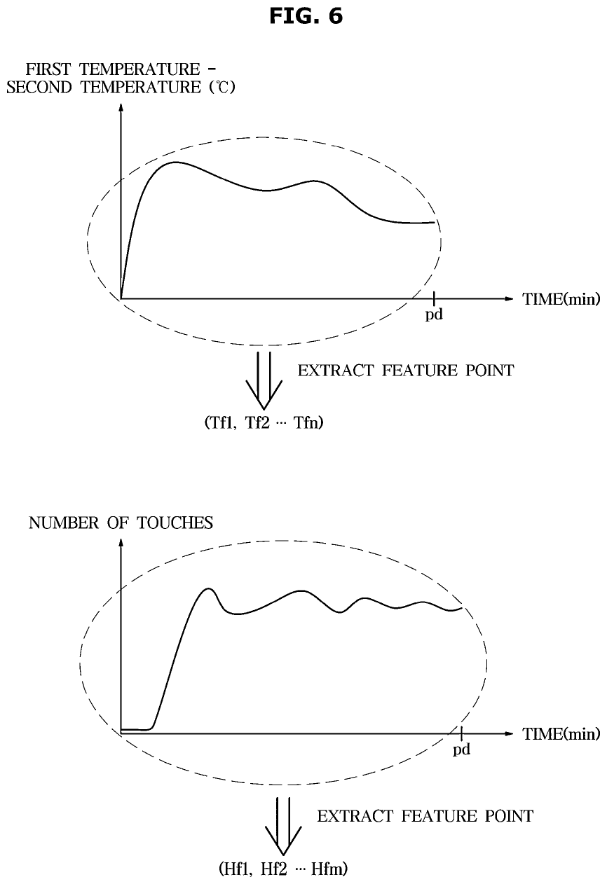

FIG. 6 conceptually illustrates extracting a plurality of feature points, according to an embodiment.

Referring to FIG. 6, the extracting of temperature feature points Tf1, Tf2, . . . , Tfn based on the processing of the first temperature data and the second temperature data may include extracting the temperature feature points Tf1, Tf2, . . . , Tfn based on a difference between temperature (first temperature) of the air heated by the heating element 200 and temperature of the inside 30a of the drum. There may be at least one temperature feature point Tf1, Tf2, . . . , Tfn.

Specifically, the processor 301 may extract the temperature feature points Tf1, Tf2, . . . , Tfn based on a difference between the first temperature value included in the first temperature data and the second temperature value included in the second temperature data.

According to the disclosure, much more useful feature points may be extracted than extracting feature points based on only the first temperature value or than extracting feature points based on only the second temperature value.

In various embodiments, the processor 301 may extract the difference itself between the first temperature and the second temperature per unit time (e.g., one minute) as a first temperature feature point Tf1.

In various embodiments, the processor 301 may extract a value corresponding to a gradient in difference between the first temperature and the second temperature as a second temperature feature point Tf2.

The gradient in difference between the first temperature and the second temperature may include an amount of change in difference between the first temperature and the second temperature per unit time (e.g., per one minute).

In various embodiments, the temperature feature points Tf1, Tf2, . . . , Tfn may include a value obtained by correcting the difference between the first temperature and the second temperature depending on the weight of the laundry. For example, the processor 301 may extract the third temperature feature point Tfn by assigning (giving) a weight value corresponding to the weight of the laundry to the difference between the first temperature and the second temperature.

An instruction for performing the operation of extracting the temperature feature points Tf1, Tf2, . . . , Tfn based on the processing of the first temperature data and the second temperature data may be stored in the memory 302.

As thermal capacity of the laundry is different depending on the material of the laundry, the value corresponding to the temperature feature point Tf1, Tf2, . . . , Tfn calculated based on the difference between the first temperature and the second temperature may be different for a different material of the laundry.

The processor 301 may extract the temperature feature point Tf1, Tf2, . . . , Tfn by processing the first temperature data and the second temperature data until a lapse of a predetermined time pd after the start of the drying process.

According to the disclosure, to use the fact that thermal capacity is different for each material of the laundry, the temperature feature point Tf1, Tf2, . . . , Tfn calculated based on the difference between the first temperature and the second temperature may be used as one of input data items to the AI model, thereby facilitating correct material detection.

According to the disclosure, by giving a weight value corresponding to the weight of the laundry to the difference between the first temperature and the second temperature, compensation is made for the change in thermal capacity depending on the weight of the laundry, so that only the temperature feature point Tf1, Tf2, . . . , Tfn corresponding to the change in thermal capacity depending on the material of the laundry may be extracted.

The extracting of the dryness feature point Hf1, Hf2, . . . , Hfm based on the processing of the dryness data may include extracting dryness feature points Hf1, Hf2, . . . , Hfm based on the number of touches per unit time. There may be at least one dryness feature point Hf1, Hf2, . . . , Hfm.

Specifically, the processor 301 may extract the dryness feature point Hf1, Hf2, . . . , Hfm based on the number of touches (or number of contacts) per unit time, which is included in the dryness data. A gradient in the number of touches per unit time may include a slope of a plot corresponding to the number of touches detected by the dryness sensor 160.

In various embodiments, the processor 301 may extract the number of touches itself per unit time (e.g., one minute) as the first dryness feature point Hf1.

In various embodiments, the processor 301 may extract a value corresponding to a gradient in the number of touches per unit time as a second dryness feature point Hf2.

The gradient in the number of touches per unit time may include an amount of change in the number of touches per unit time (e.g., one minute).

In various embodiments, the dryness feature point Hf1, Hf2, . . . , Hfm may include a corrected gradient obtained by correcting the gradient in the number of touches per unit time based on the weight of the laundry. For example, the processor 301 may extract the third dryness feature point Hfm by giving a weight value corresponding to the weight of the laundry to the number of touches per unit time.

An instruction for performing the operation of extracting the dryness feature point Hf1, Hf2, . . . , Hfm based on the processing of the dryness data may be stored in the memory 302.

As moisture content of the laundry is different depending on the material of the laundry, the value corresponding to the dryness feature point Hf1, Hf2, . . . , Hfm calculated based on the dryness data may be different for a different material of the laundry.

The processor 301 may extract the dryness feature point Hf1, Hf2, . . . Hfm by processing the dryness data until a lapse of predetermined time pd after the start of the drying process. Information about the predetermined time pd may be stored in the memory 302 in advance in the process of manufacturing the dryer 1, received from an external device through the communication interface 330, or set by the user. For example, the predetermined time pd may be set to about 20 minutes. In various embodiments, the predetermined time pd may vary depending on when the first temperature reaches a predetermined temperature.

According to the disclosure, to use the fact that moisture content is different for each material of the laundry, the dryness feature point Hf1, Hf2, . . . , Hfm calculated based on the dryness data is used as one of input data items to the AI model, thereby facilitating correct material detection.

According to the disclosure, by giving a weight value corresponding to the weight of the laundry to the number of touches per unit time, compensation is made for the change in moisture content depending on the weight of the laundry, so that only the dryness feature point Hf1, Hf2, . . . , Hfm corresponding to the change in moisture content depending on the material of the laundry may be extracted.

The processor 301 may perform operation 1400 of identifying the material of the laundry based on a performance time of the drying process reaching the predetermined time pd in 1300.

The performance time of the drying process refers to an elapsed time after the start of the drying process.

In an embodiment, the processor 301 may extract temperature feature points based on the processing of the first temperature data and the second temperature data and extract dryness feature points based on the processing of the dryness data until the performance time of the drying process reaching the predetermined time pd.

In an embodiment, the processor 301 may extract the temperature feature point by processing the first temperature data and the second temperature data produced by the first temperature sensor 251 and the second temperature sensor 252 until the performance time of the drying process reaching the predetermined time pd, and extract the dryness feature point by processing the dryness data produced by the dryness sensor 160 until the performance time of the drying process reaching the predetermined time pd.

In response to the performance time of the drying process reaching the predetermined time pd in 1300, the processor 301 may identify the material of the laundry by inputting the temperature feature point and the dryness feature point to an AI model in 1400.

The AI model may be trained using the temperature feature point and the dryness feature point as input data to output data about the material of the laundry.

In an embodiment, the AI model may be stored in the memory 302 and/or an external device (e.g., server).

When the AI model is stored in the memory 302, the processor 301 may identify the material of the laundry by inputting the temperature feature point and the dryness feature point to the AI model stored in the memory 302.

When the AI model is stored in the external device only, the processor 301 may transmit information about the temperature feature point and the dryness feature point to the external device through the communication interface; the external device may obtain information about the material of the laundry by inputting the temperature feature point and the dryness feature point received from the dryer 1 to the AI model; the external device may send information about the material of the laundry to the dryer 1; as a result, the processor 301 may identify the material of the laundry.

Specifically, operation 1400 of identifying, by the processor 301, the material of the laundry by inputting the temperature feature point and the dryness feature point to the AI model may include operation of identifying, by the processor 301, the material of the laundry by inputting the temperature feature point and the dryness feature point to the AI model stored in the memory 302, and/or operation of identifying, by the processor 301, the material of the laundry by transmitting information about the temperature feature point and the dryness feature point to the external device through the communication interface 330 and receiving information about the material of the laundry from the external device.

According to the disclosure, as the processor 301 extracts the feature points that needs to be input to the AI model until a predetermined time elapses after the start of the drying process, and inputs the feature points to the AI model after reliability on the feature points are obtained to some extent over time, the processor 301 may identify the material of the laundry more accurately.

In an embodiment, the AI model is trained to identify the material based on the feature points, and may be configured to give a weight to each of the feature points and obtain a value corresponding to the material of the laundry through an operation.

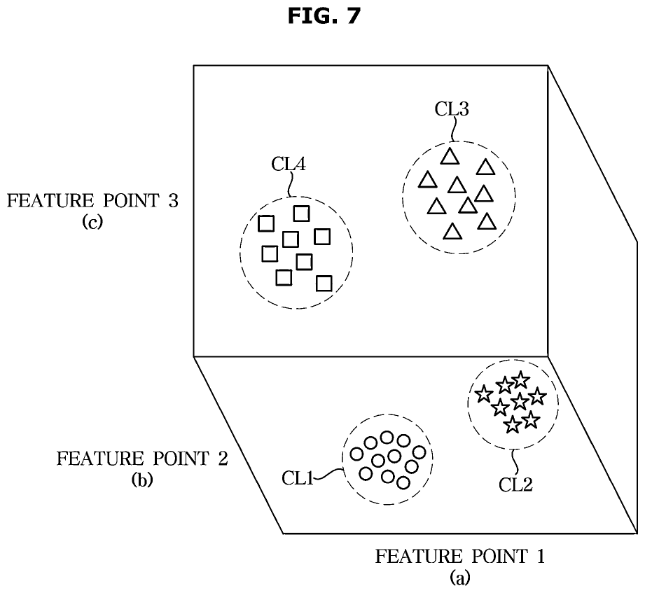

FIG. 7 conceptually illustrates clusters of laundry materials corresponding to a plurality of feature points, according to an embodiment.

Referring to FIG. 7, materials of the laundry may be clustered according to a plurality of feature points a, b and c.

Although three feature points a, b and c are shown, the number of the feature points is not limited thereto.

The plurality of feature points a, b and c may include the aforementioned temperature feature points Tf1, Tf2, . . . , Tfn and the dryness feature points Hf1, Hf2, . . . , Hfm.

Materials of the laundry may be clustered by being classified by the plurality of feature points a, b and c.

For example, a first material may correspond to a first cluster CL1, a second material may correspond to a second cluster CL2, a third material may correspond to a third cluster CL3 and a fourth material may correspond to a fourth cluster CL4.

The AI model is trained to identify the material of the laundry from the plurality of feature points a, b and c based on the clustering tendency.

Referring to an example of FIG. 7, the first cluster CL1 and the second cluster CL2 have no meaningful difference in feature point 3(c), have a meaningful but little difference in feature point 2(b), and have a big difference in feature point 1(a).

In an embodiment, to distinguish the first cluster CL1 from the second cluster CL2, the AI model may be trained to give a larger weight to feature point 1(a) than to feature point 2(b) when feature point 3(c) has values corresponding to the first cluster CL1 and the second cluster CL2.

Referring to another example of FIG. 7, the first cluster CL1 and the fourth cluster CL4, or the second cluster CL2 and the third cluster CL3 have no meaningful difference in feature point 1(a) and feature point 2(b) but have a big difference in feature point 3(c).

In an embodiment, to distinguish the first cluster CL1 from the fourth cluster CL4 or distinguish the second cluster CL2 from the third cluster CL3, the AI model may be trained to give a larger weight to feature point 3(c) than to feature point 1(a) or feature point 2(b).

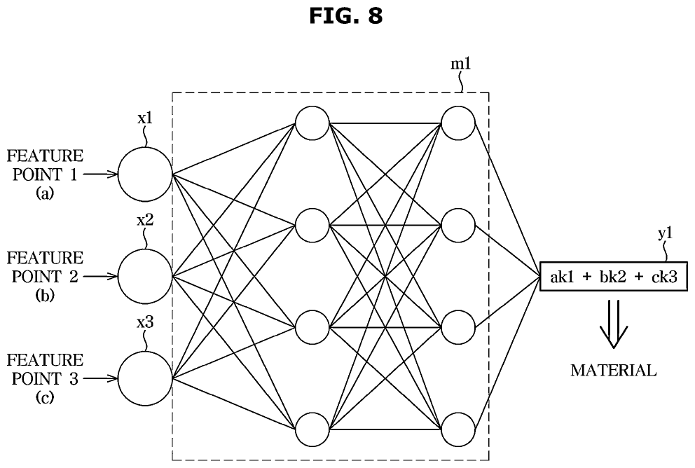

FIG. 8 conceptually illustrates a procedure in which a plurality of feature points are input to an AI model and a material of laundry is identified, according to an embodiment.

An AI model m1 is characterized by being made by learning. Specifically, the AI model being made by learning refers to the predefined operation rule or the AI model established to perform a desired feature (or an object) being made when a basic AI model is trained by a learning algorithm with a lot of training data. Such learning may be performed by a device itself in which AI is performed according to the disclosure, or by a separate server and/or system. Examples of the learning algorithm may include supervised learning, unsupervised learning, semi-supervised learning, or reinforcement learning, without being limited thereto.

The AI model (m1) may be made up of a plurality of neural network layers. Each of the plurality of neural network layers may have a plurality of weight values, and perform neural network operation through operation between an operation result of the previous layer and the plurality of weight values. The plurality of weight values owned by the plurality of neural network layers may be optimized by learning results of the AI model m1. For example, the plurality of weights may be updated to reduce or minimize a loss value or a cost value obtained by the AI model m1 during a training procedure. An artificial neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, without being limited thereto.

Referring to FIG. 8, the AI model m1 may include an input layer including a plurality of input terminals (e.g., a first input terminal x1, a second input terminal x2 and/or a third input terminal x3).

The feature point extracted by the processor 301 may be input to each of the plurality of input terminals x1, x2 and x3.

For example, feature point 1(a) may be input to the first input terminal x1, feature point 2(b) may be input to the second input terminal x2, feature point 3(c) may be input to the third input terminal x3.

In various embodiments, feature points 1(a) and 2(b) may be at least one dryness feature point Hf1, Hf2, . . . Hfm, and feature point 3(c) may be at least one temperature feature point Tf1, Tf2, . . . Tfn.

The AI model m1 may output a value related to a material through an output terminal y1 based on the feature points input to the plurality of input terminals (e.g., first input terminal x1, the second input terminal x2 and/or the third input terminal x3).

In an embodiment, the AI model m1 may calculate the value related to a material by giving different weights k1, k2 and k3 to the feature points input to the plurality of input terminals (e.g., first input terminal x1, the second input terminal x2 and/or the third input terminal x3).

For example, the AI model m1 may give a first weight k1 to the first feature point 1(a) input through the first input terminal x1, a second weight k2 to the second feature point 2(b) input through the second input terminal x2, a third weight k3 to the third feature point 3(c) input through the third input terminal x3, and add them up and output the result to an output terminal y1.

In an embodiment, the AI model m1 may be configured to calculate a first value akl by giving the first weight k1 to the temperature feature point Tf1, Tf2, . . . Tfn, a second value bk2 and/or ck3 by giving the second weight k2 to the dryness feature point Hf1, Hf2, . . . Hfm, and identify the material of the laundry based on the first value and the second value.

In various embodiments, the feature point 1(a), the feature point 2(b), and the feature point 3(c) may be vectors including size and direction. Hence, the feature point may also be referred to as a feature vector.

The AI model m1 may identify a cluster corresponding to a value (vector) output through the output terminal y1 and identify a material corresponding to the identified cluster.

The weights k1, k2 and k3 given to the feature points may be updated according to training of the AI model m1.

Turning back to FIG. 5, the processor 301 may change the dry setting of the dryer 1 based on the identified material, in 1500. The changing of the dry setting of the dryer 1 may include changing a dry setting that has been applied since the drying process began.

According to operation 1500, the dry setting of the drying process may be changed to a dry setting corresponding to the material until the end of the drying process.

For example, the processor 301 may start a drying process according to a default dry setting of the dryer 1, and change the default dry setting to a dry setting corresponding to the identified material in response to the identifying of the material.

In other words, the processor 301 may change the dry setting from the default dry setting to a dry setting corresponding to the identified material in response to the identifying of the material of the laundry.

The processor 301 may perform a drying process based on the changed dry setting, and terminate the drying process in 1700 based on completing of the drying process according to the changed dry setting in 1600.

According to the disclosure, provided is the dryer 1 that is able to accurately identify a material of the laundry through an AI model and thus, perform a drying process with a dry setting that is suitable for the material of the laundry.

According to the disclosure, changing the dry setting depending on the material of the laundry may facilitate optimal dry efficiency without damaging the material of the laundry.

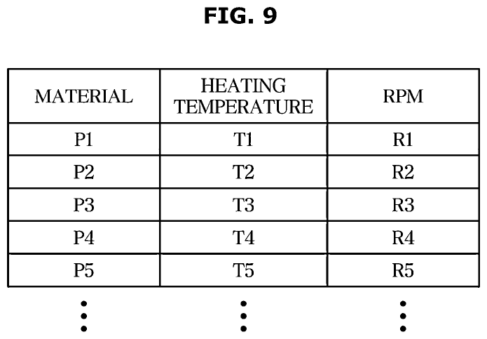

FIG. 9 illustrates an example of a dry setting corresponding to a material of laundry, according to an embodiment.

Referring to FIG. 9, a dry setting may include at least one of the rotation speed of the drum 120, the rotation speed of the blower fan 151, or heating temperature of the heating element 200. Although not shown, the dry setting may include an operation time of the drying process.

The rotation speed of the drum 120 and/or the rotation speed of the blower fan 151 are represented with RPM in FIG. 9.

The rotation speed of the drum 120 and/or the rotation speed of the blower fan 151 may include rotation speed of the motor of the driving device 60.

A dry setting may depend on the material.

For example, the heating temperature of the heating element 200 may be set to a first heating temperature T1 and the rotation speed of the motor may be set to first RPM (R1) for a first material P1.

The heating temperature of the heating element 200 may be set to a second heating temperature T2 and the rotation speed of the motor may be set to second RPM (R2) for a second material P2.

The heating temperature of the heating element 200 may be set to a third heating temperature T3 and the rotation speed of the motor may be set to third RPM (R3) for a third material P3.

The heating temperature of the heating element 200 may be set to a fourth heating temperature T4 and the rotation speed of the motor may be set to fourth RPM (R4) for a fourth material P4.

The heating temperature of the heating element 200 may be set to a fifth heating temperature T5 and the rotation speed of the motor may be set to fifth RPM (R5) for a fifth material P5.

As such, different heating temperatures T1, T2, T3, T4 and T5 and motor rotation speeds R1, R2, R3, R4 and R5 of the driving device 60 may be applied to the plurality of materials P1, P2, P3, P4 and P5 to minimize damage to the material and increase dry efficiency.

As described above, different operation times of the drying process may be applied for the plurality of materials P1, P2, P3, P4 and P5 to minimize damage to the material and increase dry efficiency.

The memory 302 may store the dry settings corresponding to the plurality of materials.

In an embodiment, the default dry setting may be a dry setting that corresponds to a material most susceptible to damage among the plurality of materials.

According to the disclosure, by presetting the default dry setting to the dry setting corresponding to the material most susceptible to damage among the plurality of materials, an occasion when a material of the laundry is damaged may be avoided in advance.

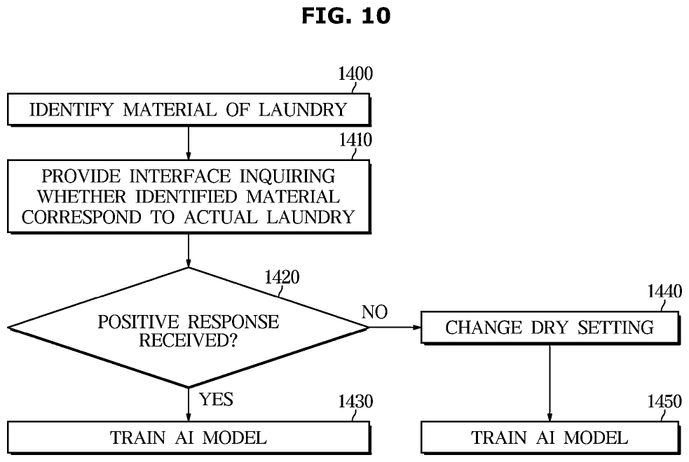

FIG. 10 is a flowchart illustrating an example of a procedure for training an AI model, according to an embodiment.

Referring to FIG. 10, the AI model may be continuously updated with the use of the dryer 1.

In an embodiment, as described above, a method of controlling the dryer 1 may include identifying a material of the laundry, in 1400.

The identifying of the material of the laundry in 1400 was described with reference to FIG. 5, so the description thereof will not be repeated.

The method of controlling the dryer 1 may include providing an interface inquiring whether the identified material is equal to an actual material of the laundry, in 1410.

In various embodiments, the providing of the interface inquiring whether the identified material is equal to the actual material of the laundry in 1410 may be finally performed by the dryer 1 or by an external device.

In an embodiment, the processor 301 may control the user interface device 40 to provide the interface inquiring whether the identified material is equal to the actual material of the laundry.

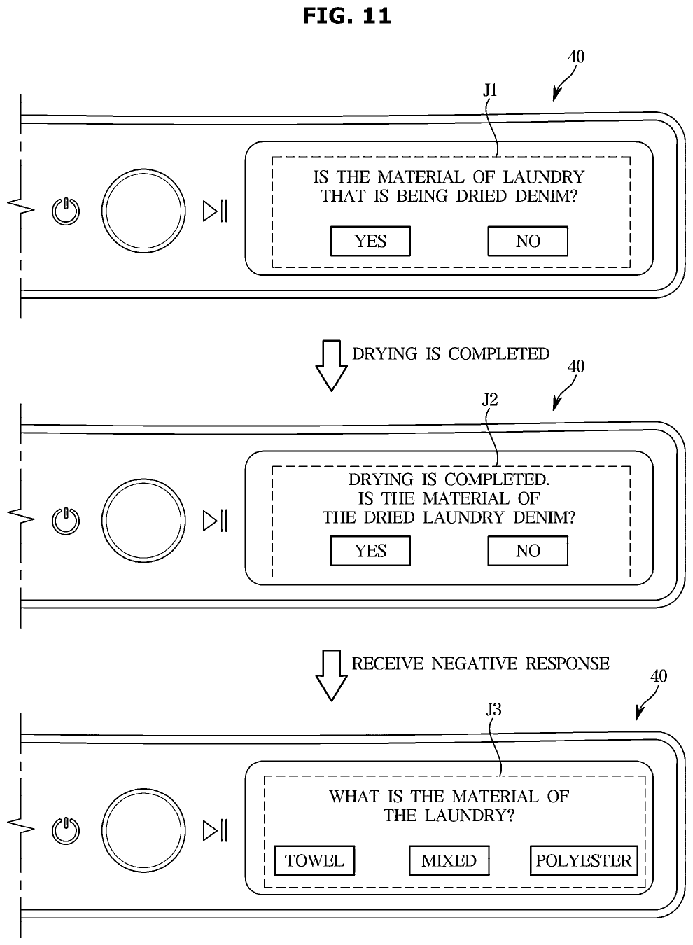

FIG. 11 illustrates an example of an interface provided by a user interface device of a dryer, according to an embodiment.

Referring to FIG. 11, the processor 301 may control the user interface device 40 to provide an interface J1, J2 or J3 inquiring whether the identified material is equal to the actual material of the laundry, in response to the identifying of the material.

In an embodiment, the interface inquiring whether the identified material is equal to the actual material of the laundry may include information about the identified material. In an embodiment, the interface inquiring whether the identified material is equal to the actual material of the laundry (hereinafter, inquiring interface) may include an interface element inquiring whether the identified material is equal to the actual material of the laundry (hereinafter, inquiring element).

In an embodiment, the interface inquiring whether the identified material is equal to the actual material of the laundry may be provided during the drying process.

In other words, in an embodiment, the user interface device 40 may output the inquiring interface J1 during the drying process.

In an embodiment, the inquiring interface J2 may be provided in response to competing of the drying process.

In other words, in an embodiment, the user interface device 40 may output the inquiring interface J2 in response to completing of the drying process.

The inquiring interface J1, J2 or J3 may be configured to inquire about an actual material of the laundry in response to receiving of a response that the identified material is different from the actual material of the laundry.

In an embodiment, the processor 301 may determine the identified material as the actual material of the laundry in response to receiving a positive response through the inquiring interface J1 or J2. The positive response refers to a response that the identified material is equal to the actual material of the laundry.

The processor 301 may maintain the dry setting as is based on the receiving of the positive response in 1420 during the drying process.

Furthermore, the processor 301 may train the AI model in 1430 based on the receiving of the positive response in 1420 during the drying process or after the drying process is completed.

The training of the AI model in 1430 may include training the AI model by using data related to the feature points a, b and c extracted during the drying process and data about a material identified by the AI model as training data.

In an embodiment, the user interface device 40 may output the inquiring interface J3 inquiring about an actual material of the laundry in response to receiving a negative response through the inquiring interface J1 or J2.

The negative response refers to a response that the identified material is different from the actual material of the laundry.

The inquiring interface J3 provided in response to the receiving of the negative response may include an interface element for selecting a material of the laundry.

In an embodiment, the interface element for selecting a material of the laundry may include a visual indicator (e.g., text) indicating a material of the laundry.

In an embodiment, when performing the identifying of the material of the laundry, the processor 301 identifies the material of the laundry based on a probability distribution that the material of the laundry is a certain material.

For example, in the example of FIG. 7, a probability that a value about a material of the laundry obtained through the AI model corresponds to the first cluster CL may be determined to be 80%, a probability of corresponding to the second cluster CL2 may be determined to be 15%, and a probability of corresponding to the third cluster CL3 may be determined to be 5%.

In this case, the processor 301 identifies the material corresponding to the first cluster CL having the highest probability as the material of the laundry.

Specifically, the processor 301 may identify a material corresponding to a cluster identified with the highest priority as a material of the laundry, and a material corresponding to a cluster identified with a lower priority may be temporarily stored in the memory 302.

The processor 301 may provide an interface element for selecting a material corresponding to the cluster identified with the lower priority through the inquiring interface J3 provided in response to the receiving of the negative response.

In other words, the inquiring interface J3 may include an interface element for selecting a material corresponding to the cluster identified with the lower priority.

According to the disclosure, as it is more likely that the interface element for selecting a material corresponding to the actual material of the laundry is arranged on the inquiring interface J3, it may lead the user to make an easy choice.

The user interface device 40 may receive information about the actual material of the laundry from the user through the inquiring interface J3 that inquires about the actual material of the laundry. In other words, the processor 301 may receive the information about the actual material of the laundry that is different from the identified material through the inquiring interface J3.

The processor 301 may change the dry setting to a dry setting corresponding to the actual material of the laundry in 1440 based on the receiving of the negative response in 1420 during the drying process.

A time at which the identifying of the material is completed is when the predetermined time pd elapses after the start of the drying process. The user usually leaves the place after inputting a command to start drying to the dryer 1.

Hence, it is more likely that the user may not check the inquiring interface J1 provided through the user interface device 40 during the drying process.

Accordingly, in an embodiment, the operation of providing the inquiring interface J1 through the user interface device 40 may not be performed during the drying process.

On the other hand, the user may happen to check the user interface device 40 during the drying process and input a positive response or negative response.

In an embodiment, the processor 301 may change the dry setting to a dry setting corresponding to the actual material of the laundry in 1440 based on the receiving of the negative response in 1420 during the drying process.

Specifically, on receiving, from the user, the information about the actual material of the laundry different from the material identified by the AI model, the processor 301 may change the dry setting corresponding to the material identified by the AI model to a dry setting corresponding to the actual material of the laundry.

In an embodiment, the processor 301 may train the AI model in 1450 based on the receiving of the negative response in 1420 during the drying process.

The training of the AI model in 1450 may include training the AI model by using data related to the feature points a, b and c extracted during the drying process, data about the material identified by the AI model and/or data about the actual material of the laundry received from the user as training data.

According to the disclosure, even an occasion when a wrong material is identified by the AI model for the laundry may be corrected through the user's intervention.

According to the disclosure, accuracy in material identification of the AI model may be increased by using the actual material information as training data for training the AI model when the wrong material is identified by the AI model for the laundry.

In an embodiment, the processor 301 may transmit information about the identified material to an external device through the communication interface 330 such that the external device may provide an interface inquiring whether the identified material is equal to the actual material of the laundry.

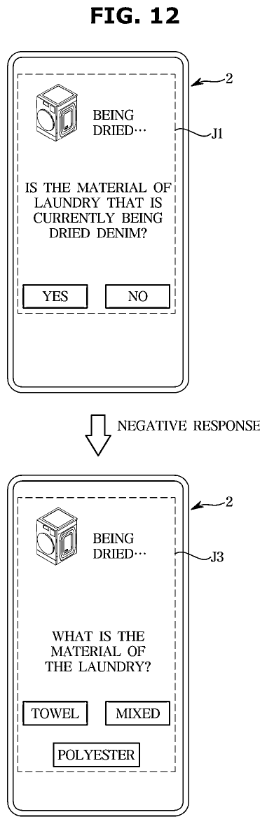

FIG. 12 illustrates an example of an interface provided through an external device that receives material information from a dryer, according to an embodiment.

Referring to FIG. 12, the processor 301 may transmit information about the identified material to an external device through the communication interface 330 such that that the external device may provide an interface J1, J2 or J3 inquiring whether the identified material is equal to the actual material of the laundry, in response to the identifying of the material.

Although FIG. 12 shows only the inquiring interface J1 provided during the drying process and the inquiring interface J3 provided in response to receiving of the negative response through the inquiring interface J1 among the inquiring interfaces J1, J2 and J3 provided by the external device, it is obvious that the external device may also provide the inquiring interface J2 in response to completing of the drying process.

As described above, it is more likely that the user may not check the inquiring interface J1 provided through the user interface device 40 during the drying process.

In an embodiment, the processor 301 may transmit information about the identified material to the external device through the communication interface 330 such that the external device may provide the interface J1 inquiring whether the identified material is equal to the actual material of the laundry, in response to the identifying of the material.

The external device may include the user equipment 2. The transmitting, by the processor 301, the information about the identified material to the external device may include transmitting, by the processor 301, the information about the identified material to a server such that the server may transmit the information about the identified material to the user equipment 2. The transmitting, by the processor 301, the information about the identified material to the external device may include transmitting, by the processor 301, the information about the identified material directly to the user equipment 2.

The user equipment 2 may be carried by the user or placed at the user's home or office. The user equipment may include a personal computer, a terminal, a mobile phone, a smart phone, a handheld device, a wearable device, a display device, etc., without being limited thereto.

On receiving the positive response through the inquiring interface J1, the user equipment 2 may forward the positive response to the dryer 1. The processor 301 may determine the identified material as an actual material of the laundry in response to receiving the positive response from the user equipment 2 through the communication interface 330.

The processor 301 may maintain the dry setting as is based on the receiving of the positive response in 1420 during the drying process.

Furthermore, the processor 301 may train the AI model in 1430 based on the receiving of the positive response in 1420 during the drying process or after the drying process is completed.

The training of the AI model in 1430 may include training the AI model by using data related to the feature points a, b and c extracted during the drying process and data about a material identified by the AI model as training data.

The user equipment 2 may output the inquiring interface J3 inquiring about an actual material of the laundry in response to receiving of the negative response through the inquiring interface J1.

The user equipment 2 may receive information about the actual material of the laundry from the user through the inquiring interface J3 that inquires about the actual material of the laundry. In other words, the processor 301 may receive the information about the actual material of the laundry that is different from the identified material through the inquiring interface J3.

The user equipment 2 may forward the information about the actual material of the laundry received through the inquiring interface J3.

In an embodiment, the processor 301 may change the dry setting to a dry setting corresponding to the actual material of the laundry in 1440 based on the receiving of the information about the actual material of the laundry from the user equipment 2 in 1420 during the drying process.

In an embodiment, the processor 301 may train the AI model in 1450 based on the receiving of the information about the actual material of the laundry in 1420 from the user equipment 2 during the drying process.

According to the disclosure, by providing the inquiring interface J1 through the user equipment 2 at a time when the completing of identifying of the material of the laundry by the AI model, a setting of the drying process may be quickly changed into a process corresponding to the actual material even when the identifying of an accurate material is failed.

In various embodiments, when the AI model is stored in the server, the server may perform the operation 1430 and 1450 of training the AI model.

In an embodiment, the server may receive the aforementioned training data or training data as will be described below from the dryer 1 and/or the user equipment 2, and using this, train the AI model.

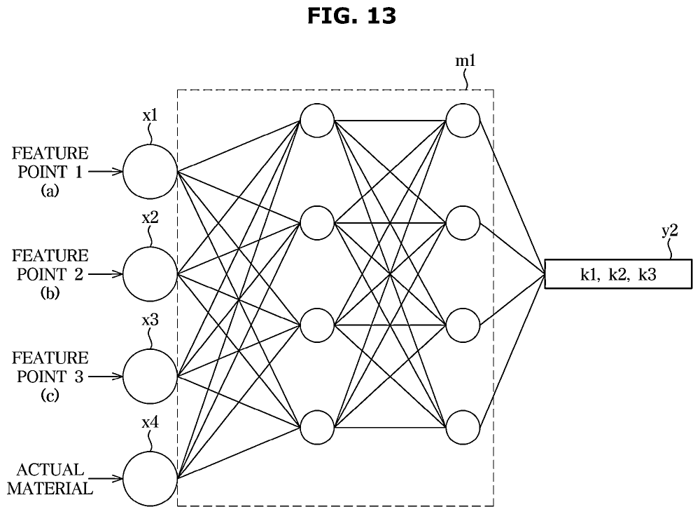

FIG. 13 conceptually illustrates training of an AI model, according to an embodiment.

Referring to FIG. 13, the AI model m1 may include an input layer including the plurality of input terminals (e.g., the first input terminal x1, the second input terminal x2 and/or the third input terminal x3).

The first input terminal x1, the second input terminal x2 and the third input terminal x3 were described above, so the description thereof will not be repeated.

Data about an actual material may be input to a fourth input terminal x4.

The data about the actual material may include data about an actual material selected according to a user input.

For example, when the positive response is received through the inquiring interface J1 or J2, the data about the actual material selected according to the user input may refer to data about a material identified by the AI model.

In another example, when the actual material is selected through the inquiring interface J3, the data about the actual material selected according to the user input may refer to data about a material obtained through the inquiring interface J3.

The AI model m1 may be trained based on the data about the actual material being input to the fourth input terminal x4.

In various embodiments, although not shown, the AI model may further include a fifth input terminal to which data about a material identified by the AI model is input.

In an embodiment, the AI model m1 may be trained based on first data related to the temperature feature point extracted by the processor 301, second data related to the dryness feature point extracted by the processor 301, third data related to a material identified by the AI model based on the temperature feature point and the dryness feature point, and fourth data related to an actual material of the laundry selected according to a user input.

The AI model m1 may output a value related to a weight k1, k2 or k3 given to each of the feature points through an output terminal y2 based on the training data input to the plurality of input terminals x1, x2, x3 and x4.

In an embodiment, as a result of the training, the AI model m1 may update the first weight k1 given to the temperature feature point Tf1, Tf2, . . . , Tfn and update the second weight k2 given to the dryness feature point Hf1, Hf2, . . . Hfm.

Specifically, the training of the AI model m1 may include updating the first weight k1 given to the temperature feature point Tf1, Tf2, . . . , Tfn the second weight k2 given to the dryness feature point Hf1, Hf2, . . . , Hfm.

According to the disclosure, as the AI model may be continuously trained based on the data about an actual material selected according to a user input, accuracy of the AI model in identifying the material may increase when the dryer 1 performs more drying processes.

Furthermore, according to the disclosure, when multiple users use the dryer 1, the AI model may be rapidly trained by using abundant training data.

According to an embodiment of the disclosure, a dryer (1) may include a drum (120), a heating element (200); a blower fan (151) blowing air heated by the heating element (200) into the drum (120); a first temperature sensor (251) configured to detect temperature of the air heated by the heating element (200) and produce first temperature data corresponding the temperature of the air heated by the heating element (200); a second temperature sensor (252) configured to detect temperature in the drum (120) and produce second temperature data corresponding the temperature in the drum (120); a dryness sensor (160) arranged in the drum (120) and configured to detect a dryness level of laundry in the drum (120) and produce dryness data corresponding to the dryness level of the laundry in the drum; and at least one processor (301) configured to extract a temperature feature point based on processing of first temperature data produced by the first temperature sensor (251) and second temperature data produced by the second temperature sensor (252), extract a dryness feature point based on processing of dryness data produced by the dryness sensor (160), identify a material of the laundry by inputting the temperature feature point and the dryness feature point to an AI model, and change a dry setting of the dryer (1) based on the identified material.

The at least one processor (301) may extract the temperature feature point based on a difference between temperature of air heated by the heating element (200) and temperature in the drum (120).

The at least one processor (301) may start a drying process according to a default dry setting in response to receiving a command to start drying, and perform an operation of identifying a material of the laundry in response to a lapse of a predetermined time after the start of the drying process.

The at least one processor (301) may change the dry setting from the default dry setting to a dry setting corresponding to the identified material in response to the identifying of the material of the laundry.

The at least one processor (301) may control the user interface device (40) to provide an interface (J1, J2 or J3) inquiring whether the identified material corresponds to an actual material of the laundry, in response to the identifying of the material of the laundry.

The at least one processor (301) may transmit information about the identified material to the external device (2) through the communication interface such that the external device (2) provides an interface (J1, J2 or J3) inquiring whether the identified material corresponds to an actual material of the laundry, in response to the identifying of the material of the laundry.

The interface (J1, J2 or J3) may be configured to inquire about an actual material of the laundry in response to receiving of a response that the identified material is different from the actual material of the laundry.

The at least one processor (301) may change the dry setting to a dry setting corresponding to an actual material of the laundry in response to receiving of information about the actual material of the laundry different from the identified material through the interface (J1, J2 or J3).

The AI model may be trained based on first data related to the temperature feature point extracted by the at least one processor (301), second data related to the dryness feature point extracted by the at least one processor (301), third data related to a material identified by the AI model based on the temperature feature point and the dryness feature point, and fourth data related to an actual material of the laundry selected according to a user input.

The AI model is configured to calculate a first value by giving a first weight to the temperature feature point, calculate a second value by giving a second weight to the dryness feature point, and identify a material of the laundry based on the first value and the second value, and the training of the AI model may include updating the first weight and the second weight.

The at least one processor (301) may change the dry setting based on the identified material only when performing one of a plurality of drying courses, in which no material of the laundry is specified.

The temperature feature point may include a gradient in difference between temperature of air heated by the heating element (200) and temperature in the drum (120).

The dryness sensor (160) may include an electrode sensor for detecting a touch with a portion of the laundry, which contains moisture, during the rotation of the drum (120), and the dryness feature point may include a gradient in number of touches detected by the electrode sensor per unit time.

The dry setting may include at least one of rotation speed of the drum (120), rotation speed of the blower fan (151), heating temperature of the heating element (200), or an operation time of a drying process.

According to an embodiment of the disclosure, a method of controlling a dryer (1) may include extracting a temperature feature point based on processing of first temperature data produced by a first temperature sensor (251) corresponding to a temperature of air heated by the heating element (200) and second temperature data produced by a second temperature sensor (252) corresponding to a temperature in the drum (120); extracting a dryness feature point based on processing of dryness data produced by a dryness sensor (160) corresponding to a dryness level of laundry in the drum (120); identifying a material of the laundry by inputting the temperature feature point and the dryness feature point to an AI model; and changing a dry setting of the dryer (1) based on the identified material.

The extracting of the temperature feature point may include extracting the temperature feature point based on a difference between temperature of air heated by the heating element (200) and temperature in the drum (120).

The method of controlling the dryer (1) may further include starting a drying process according to a default dry setting in response to receiving a command to start drying; and performing an operation of identifying a material of the laundry in response to a lapse of a predetermined time after the start of the drying process.

The method of controlling the dryer (1) may further include providing an interface inquiring whether the identified material corresponds to an actual material of the laundry in response to the identifying of the material of the laundry.

The method of controlling the dryer (1) may further include changing the dry setting to a dry setting corresponding to the actual material of the laundry in response to receiving of information about the actual material of the laundry different from the identified material through the interface.

The method of controlling the dryer (1) may further include changing a dry setting of the dryer (1) based on the identified material only when performing one of a plurality of drying courses, in which no material of the laundry is specified.

Meanwhile, the embodiments of the disclosure may be implemented in the form of a recording medium for storing instructions to be carried out by a computer. The instructions may be stored in the form of program codes, and when executed by a processor, may generate program modules to perform operations in the embodiments of the disclosure. The recording media may correspond to computer-readable recording media.

The computer-readable recording medium includes any type of recording medium having data stored thereon that may be thereafter read by a computer. For example, it may be a read only memory (ROM), a random access memory (RAM), a magnetic tape, a magnetic disk, a flash memory, an optical data storage device, etc.

The computer-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a recording medium (e.g., a compact disc read only memory (CD-ROM)), through an application store (e.g., Play store™) directly between two user devices (e.g., smart phones), or online (e.g., downloaded or uploaded). In the case of online distribution, at least part of the computer program product (e.g., a downloadable app) may be at least temporarily stored or arbitrarily created in a recording medium that may be readable to a device such as a server of the manufacturer, a server of the application store, or a relay server.

The embodiments of the disclosure have thus far been described with reference to accompanying drawings. It will be obvious to those of ordinary skill in the art that the disclosure may be practiced in other forms than the embodiments of the disclosure as described above without changing the technical idea or essential features of the disclosure. The above embodiments of the disclosure are only by way of example, and should not be construed in a limited sense.

1. A dryer comprising:
a drum configured to accommodate laundry to be dried;
a heating element configured to heat air;
a fan configured to blow the heated air into the drum to dry the laundry;
a first temperature sensor configured to produce first temperature data corresponding to a temperature of the heated air;
a second temperature sensor configured to produce second temperature data corresponding to a temperature in the drum;
a dryness sensor in the drum and configured to produce dryness data corresponding to a dryness level of the laundry accommodated in the drum; and
at least one processor configured to:
extract a temperature feature point based on the first temperature data produced by the first temperature sensor and the second temperature data produced by the second temperature sensor,
extract a dryness feature point based on the dryness data produced by the dryness sensor,
identify, by an artificial intelligence (AI) model, a material of the laundry based on the temperature feature point and the dryness feature point, and
change a dry setting of the dryer based on the identified material.

2. The dryer of claim 1, wherein the at least one processor is further configured to extract the temperature feature point based on a difference between the temperature of the heated air and the temperature in the drum.

3. The dryer of claim 1, wherein the at least one processor is further configured to:
in response to a command to start drying being received, start a drying process according to a default dry setting, and
in response to a lapse of a predetermined time after the start of the drying process, identify the material of the laundry.

4. The dryer of claim 3, wherein the at least one processor is further configured to, in response to the material of the laundry being identified, change the dry setting from the default dry setting to a dry setting corresponding to the identified material.

5. The dryer of claim 1, further comprising:
a user interface device,
wherein the at least one processor is further configured to, in response to the material of the laundry being identified, control the user interface device to provide an interface presenting an inquiry as to whether the identified material is equal to an actual material of the laundry.

6. The dryer of claim 1, further comprising:
a communication interface configured to communicate with an external device,
wherein the at least one processor is further configured to, in response to the material of the laundry being identified, transmit information about the identified material to the external device through the communication interface.

7. The dryer of claim 5, wherein, based on a response to the inquiry indicating that the identified material is not equal to the actual material of the laundry being received by the interface, the at least one processor is configured to control the user interface device so that the interface presents an inquiry about the actual material of the laundry.

8. The dryer of claim 7, wherein the at least one processor is further configured to, based on a response to the inquiry about the actual material of the laundry being received by the interface, change the dry setting to a dry setting corresponding to the received response to the inquiry about the actual material of the laundry.

9. The dryer of claim 1, wherein the AI model is trained based on:
first data related to the extracted temperature feature point,
second data related to the extracted dryness feature point,
third data related to the identified material, and
fourth data related to an actual material of the laundry according to a user input.

10. The dryer of claim 9, wherein
the AI model is configured to:
calculate a first value based on a first weight assigned to the extracted temperature feature point,
calculate a second value based on a second weight assigned to the extracted dryness feature point, and
identify the material of the laundry based on the first value and the second value, and
the assigned first weight is updated and the assigned second weight is updated to train the AI model.

11. The dryer of claim 1, wherein the at least one processor is further configured to change the dry setting based on the identified material only when a drying course in which no material of the laundry is specified is performed.

12. The dryer of claim 1, wherein the temperature feature point includes a gradient corresponding to a difference between the temperature of the heated air and the temperature in the drum.

13. The dryer of claim 1, wherein
the dryness sensor includes an electrode sensor configured to detect a touch with a portion of the laundry which contains moisture during rotation of the drum, and
the dryness feature point includes a gradient corresponding to a number of touches detected by the electrode sensor per unit time.

14. The dryer of claim 1, wherein the dry setting includes at least one of a rotation speed of the drum, a rotation speed of the fan, a heating temperature of the heating element, or an operation time of a drying process.

15. A method of controlling a dryer including a drum, a heating element and a blower fan for blowing air heated by the heating element into the drum, the method comprising:
extracting a temperature feature point based on processing of first temperature data produced by a first temperature sensor for detecting temperature of air heated by the heating element and second temperature data produced by a second temperature sensor for detecting temperature in the drum;
extracting a dryness feature point based on processing of dryness data produced by a dryness sensor for detecting a dryness level of laundry in the drum;
identifying a material of the laundry by inputting the temperature feature point and the dryness feature point to an artificial intelligence (AI) model; and
changing a dry setting of the dryer based on the identified material.
